(19) United States
(12) Patent Application Publication
(10) Pub. No.: US 2024/0066466 A1
(43) Pub. Date: Feb. 29, 2024

(54) MICRO ULTRAVIOLET WASTE GAS TREATMENT DEVICE

(71) Applicant: GAOYOU GAOHE PHOTOELECTRICITY EQUIPMENT CO., LTD, Gaoyou (CN)

(72) Inventor: Shenghe ZHU, Gaoyou (CN)

(21) Appl. No.: 18/088,711

(22) Filed: Dec. 26, 2022

(30) Foreign Application Priority Data
Aug. 25, 2022 (CN) 2022110247236

(51) Int. Cl. B01D 53/86; B01D 46/10

(52) U.S. Cl. CPC B01D 53/8668; B01D 46/10; B01D 53/8696; B01D 2255/20707; B01D 2255/802; B01D 2257/708

(57) ABSTRACT

A micro ultraviolet waste gas treatment device includes a waste gas pipeline and an expansion guide groove connected with it, the outlet end of the expansion guide groove and a treatment and exhaust frame, the inlet end of the treatment and exhaust frame is separated into a plurality of spaces by a partition, each space is provided with a waste gas treatment device, the outlet end of the waste gas treatment device is connected and combined into a plurality of groups through a polymerization exhaust pipe, and each polymerization exhaust pipe is provided with a recovery pipe, the recovery pipe is polymerized at the inlet end of the waste gas pipe to form a recovery header and connected with the waste gas pipe. By expanding and directing the waste gas of the pipeline, the waste gas is directed to multiple independent treatment spaces.

### CROSS-REFERENCE TO RELATED APPLICATION

This application claims priority from the Chinese patent application 2022110247236 filed Aug. 25, 2022, the content of which is incorporated herein in the entirety by reference.

### TECHNICAL FIELD

The disclosure relates to the technical field of waste gas treatment equipment, in particular to a micro ultraviolet waste gas treatment device.

### BACKGROUND

VOCS waste gas and organic odor gas are the key components of air pollution. At present, the main means of purifying organic waste gas are still RTO and RCO incineration methods, but the incineration method has two major disadvantages: 1. Natural gas consumption. 2. Insufficient temperature will produce a large amount of dioxins.

The use of micro UV photocatalyst to degrade VOC waste gas and organic odor gas has high efficiency, long service life, no ozone generation, no natural gas consumption, stable equipment operation, long service life, low maintenance cost, and is conducive to carbon peaking and carbon neutralization. It is a relatively environment-friendly and clean waste gas treatment technology. However, compared with incineration, micro UV degradation requires full combination of waste gas and substances generated by UV activated catalyst, Due to the poor catalytic contact reaction at the corners of the device, the efficiency is low, and the existing degradation methods cannot adjust the degradation process. The process control is based on the waste gas treatment results.

### SUMMARY

The technical problem to be solved by the disclosure is to provide a micro ultraviolet waste gas treatment device, which can fully degrade industrial VOCs waste gas with controllable process and quality.

To solve the above technical problems, the technical solution adopted by the disclosure is:

A micro ultraviolet waste gas treatment device includes a waste gas pipeline and an expansion guide groove connected with it, the outlet end of the expansion guide groove and a treatment and exhaust frame, the inlet end of the treatment and exhaust frame is separated into a plurality of spaces by a partition, each space is provided with a waste gas treatment device, the outlet end of the waste gas treatment device is connected and combined into a plurality of groups through a polymerization exhaust pipe, and each polymerization exhaust pipe is provided with a recovery pipe, The recovery pipe is polymerized into the recovery header at the inlet end of the waste gas pipe and connected with the waste gas pipe. The recovery header is equipped with a recovery extractor, the waste gas pipe is equipped with a waste gas flow sensor, each recovery pipe is equipped with a recovery pipe valve, and the exhaust gas quality sensor is installed at the outlet end of the polymerization exhaust pipe. The waste gas treatment device degrades the waste gas by generating ultraviolet light and photocatalyst, The degradation power of the waste gas treatment unit is controlled.

The above treatment and exhaust frame is separated into input end and output end by the support plate. The waste gas treatment device is arranged at the input end and is fixedly connected with the support plate. The exhaust end of the waste gas treatment device extends out of the support plate and enters the output end and is connected with the polymerization exhaust pipe.

The two ends of the expansion guide groove are separated by expansion baffles, and the expansion baffles at the output end of the expansion guide groove correspond to the baffles of the treatment and exhaust frames.

The above exhaust gas flow sensor and exhaust gas quality sensor are electrically connected with the input end of the exhaust gas treatment controller, and the output end of the exhaust gas treatment controller is electrically connected with the exhaust gas treatment device, the recovery pipe valve and the recovery air extractor.

The above exhaust gas treatment controller is connected with the analog module through communication, the exhaust gas flow sensor and exhaust gas quality sensor are electrically connected with the input end of the analog module, and the output end of the analog module is electrically connected with the exhaust gas treatment device.

The above-mentioned waste gas treatment device includes a waste gas treatment frame, on which a microwave generator is fixed. The waste gas treatment frame is a frame that runs through the inside. Both ends of the waste gas treatment frame are respectively provided with an air inlet filter plate and an air outlet plate. The middle of the waste gas treatment frame is provided with a photocatalyst plate, and both sides of the photocatalyst plate are provided with ultraviolet light tubes electrically connected with the microwave generator.

The group of exhaust gas treatment devices corresponding to the polymerization exhaust pipe share a microwave generator, and the output end of the analog module is electrically connected with the microwave generator.

The said partition board is composed of vertical and horizontal straight plates. The input end of the processing and exhaust frame is divided into several cuboid spaces. The exhaust gas treatment devices in the cuboid space of the same horizontal line form a group and are connected with the polymerization exhaust pipe.

The above waste gas treatment controller is electrically connected and controlled with the recovery pipeline valve and the recovery exhauster through the control relay.

The above waste gas treatment controller is connected with the display screen for communication.

The waste gas treatment method using the micro ultraviolet waste gas treatment device is as follows:
Step 1: VOCs waste gas enters the waste gas pipe and reaches the intake end of the treatment and exhaust frame through the expansion guide slot. The waste gas flow sensor senses the current waste gas flow;
Step 2: The waste gas treatment controller calculates the initial degradation power according to the flow transmitted by the waste gas flow sensor, and generates control analog voltage/current to send to each microwave generator;
Step 3: The microwave generator receives the voltage/current of the control analog quantity, generates the microwave ultrahigh frequency electromagnetic field in the waste gas treatment frame, and generates bUVC rays from the ultraviolet lamp tube with the wavelength of. nm. The ultraviolet lamp tube uses the ultraviolet sterilization lamp driven by amalgam;
Step 4: The microwave UHF electromagnetic field pre splits the exhaust gas VOCs molecules in the space separated by the partition plate and the support plate into small molecules;
Step 5: bUVC ray is used to break bonds and photolysis VOCs gas cut into small molecules;
Step 6. At the same time of step 4 and step 5, bUVC ray irradiates TiO2 nano coating on the photocatalyst plate to catalyze the generation of hydroxy oxide radical OH, which further breaks the bond of waste gas to convert VOCs into harmless water and CO2;
Step 7: The exhaust gas quality sensor at the polymerization exhaust pipe detects the exhaust gas quality of each group and sends the detection results to the exhaust gas treatment controller, which compares the detection results with the set values to determine whether the exhaust gas quality is up to standard. If all of them are up to standard, the exhaust gas treatment is completed. If the exhaust gas quality of a group is not up to standard, go to Step 8;
Step VIII. The waste gas treatment controller controls the opening of the recovery pipeline valve of the group whose exhaust gas quality is not up to the standard, starts the recovery exhauster, and recovers the exhaust gas in the polymerization exhaust pipe of the group whose exhaust gas quality is not up to the standard to the waste gas pipeline. The waste gas treatment controller recalculates the secondary degradation power data of each group based on the data of the exhaust gas quality that is not up to the standard, and generates the control analog voltage/current and sends it to each microwave generator, Repeat steps 3 to 7 until the exhaust quality of all groups reaches the standard, stop the recovery exhauster and close the recovery pipeline valve.

A micro ultraviolet waste gas treatment device provided by the disclosure can guide the waste gas of the pipeline to multiple independent treatment spaces by expanding and guiding the waste gas of the pipeline, and fully degrade the organic matter under the triple action of the microwave ultra high frequency electromagnetic field pre splitting of the waste gas treatment device, the bond breaking photolysis of bUVC rays, and the hydroxyl oxygenate, and the degradation power can be preset and adjusted according to the pipeline flow, The degradation process can also be recycled and re degraded according to the degradation quality to achieve the goal of full degradation.

### DESCRIPTION OF DRAWINGS

The disclosure is further described below in combination with the drawings and embodiments:

FIG. 1 is the structural diagram of the micro ultraviolet waste gas treatment device of the disclosure;

FIG. 2 is a front view of the structure of the processing and exhaust frame of the disclosure;

FIG. 3 is the sectional view of B-B in FIG. 2;

FIG. 4 is a rear view of the structure of the processing and exhaust frame of the disclosure;

FIG. 5 is the structure diagram I of the expansion guide groove of the disclosure;

FIG. 6 is the structure diagram II of the expansion guide groove of the disclosure;

FIG. 7 is the structure diagram of waste gas pipeline;

FIG. 8 is the structure diagram of the waste gas treatment device;

FIG. 9 is a sectional view of the waste gas treatment device;

FIG. 10 is the electrical schematic diagram of the disclosure.

Including: treatment and exhaust frame 1, expansion guide groove 2, expansion partition 21, waste gas pipe 3, polymerization exhaust pipe 4, recovery pipe 5, recovery pipe valve 6, waste gas flow sensor 7, recovery header 8, recovery extractor 9, exhaust gas quality sensor 10, support plate 11, waste gas treatment device 12, waste gas treatment frame 121, microwave generator 122, inlet filter plate 123, outlet plate 124, photocatalyst plate 125, ultraviolet lamp tube 126, partition 13 Exhaust gas treatment controller 14, display screen 15, analog module 16, control relay 17.

### SPECIFIC EMBODIMENTS

The technical scheme of the disclosure is described in detail below in combination with the drawings and embodiments.

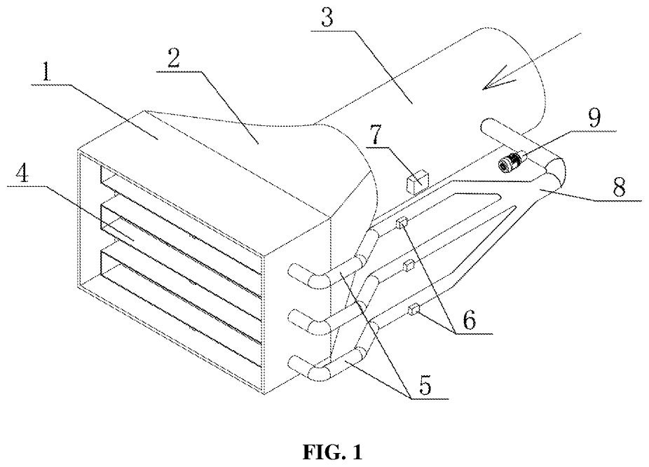

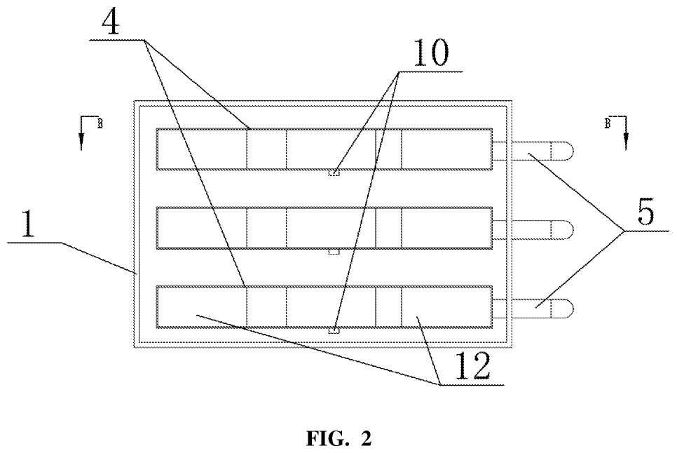

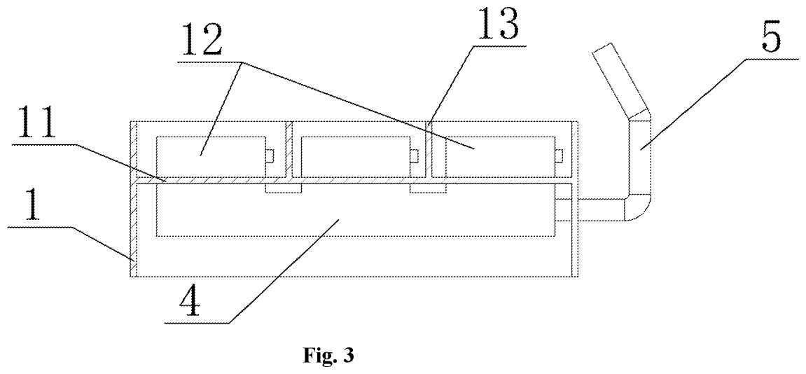

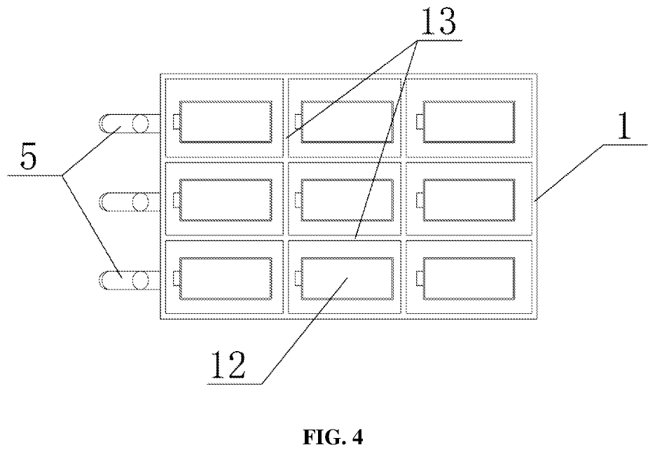

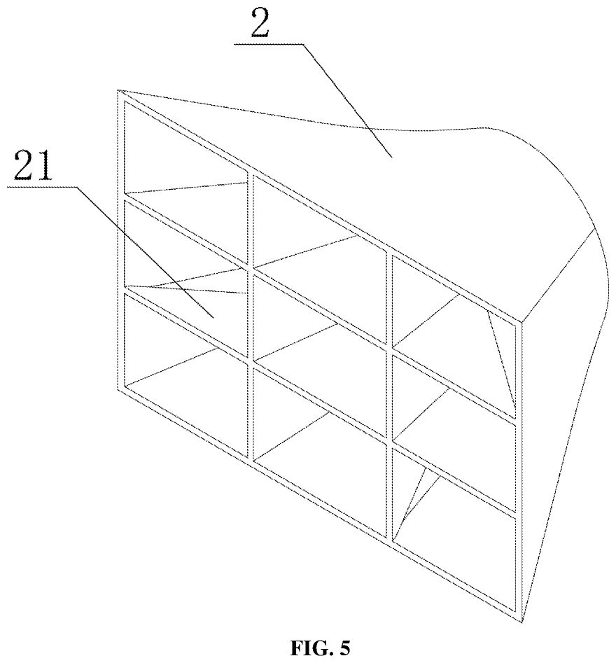

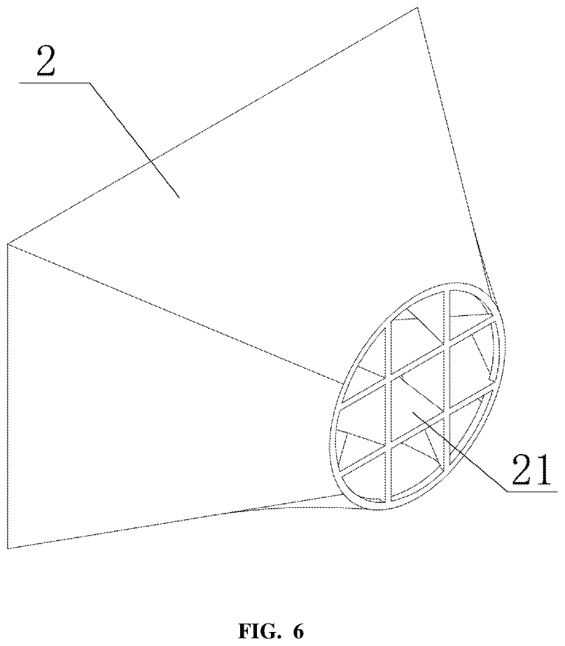

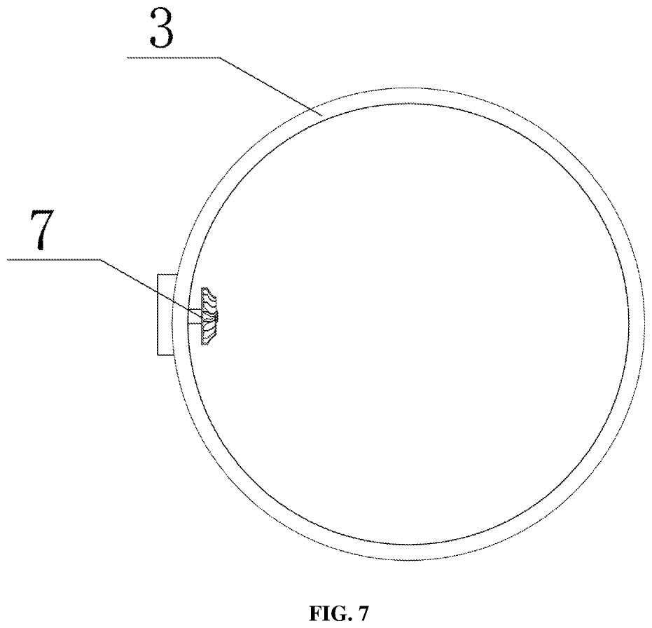

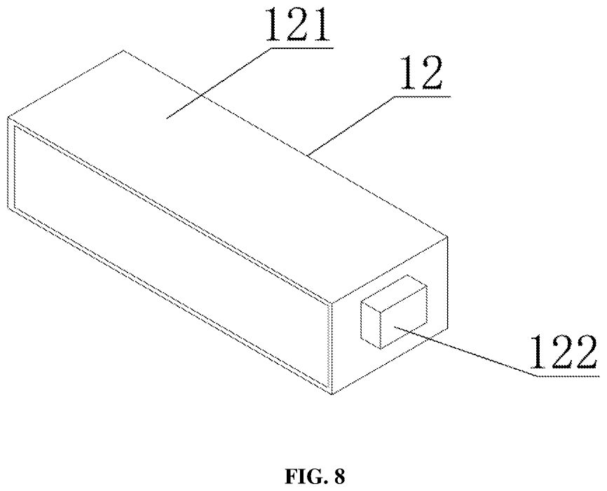

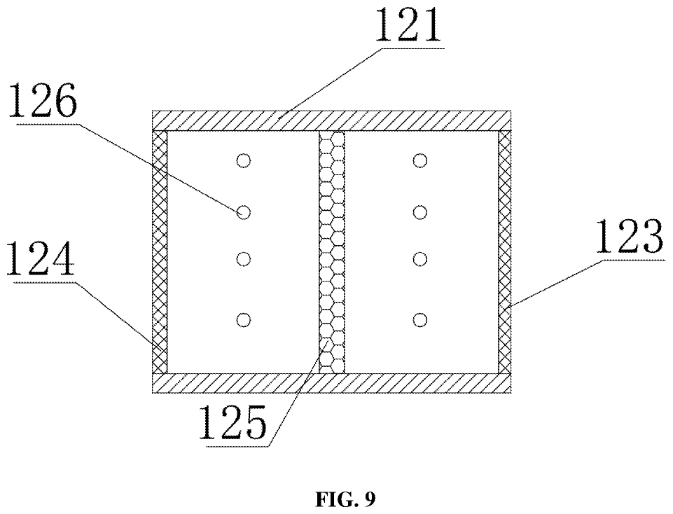

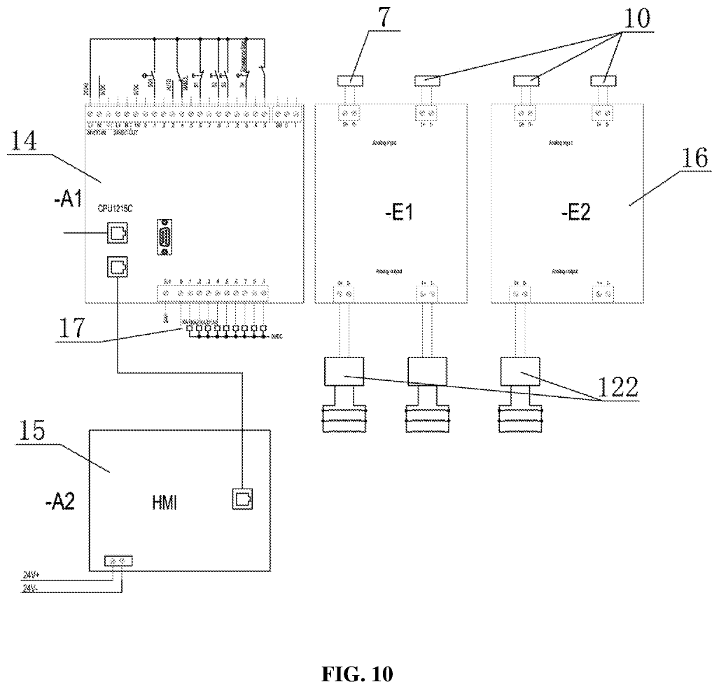

As shown in FIGS. 1-10, a micro ultraviolet waste gas treatment device includes a waste gas pipe 3 and an expansion guide groove 2 connected with it. The outlet end of the expansion guide groove 2 is separated from the treatment and exhaust frame 1. The inlet end of the treatment and exhaust frame 1 is separated into multiple spaces by the partition plate 13. Each space is equipped with a waste gas treatment device 12. The outlet end of the waste gas treatment device 12 is connected and combined into multiple groups through the polymerization exhaust pipe 4, Each polymerized exhaust pipe 4 is provided with a recovery pipe 5. The recovery pipe 5 is polymerized at the inlet end of the waste gas pipe 3 to form a recovery main pipe 8 and connected with the waste gas pipe 3. The recovery main pipe 8 is provided with a recovery exhauster 9. The waste gas pipe 3 is provided with a waste gas flow sensor 7. Each recovery pipe 5 is provided with a recovery pipe valve 6. The exhaust outlet end of the polymerized exhaust pipe 4 is provided with an exhaust gas quality sensor 10, The waste gas treatment device 12 degrades the waste gas by generating ultraviolet light and photocatalyst, and the degradation power of the waste gas treatment device 12 is controlled.

VOCs waste gas at waste gas pipeline 3 passes through expansion guide groove 2 for guidance treatment and exhaust frame 1, and enters into independent space separated by partition plate 13. In each independent space, the ultraviolet light generated by waste gas treatment device 12 reacts with TiO2 on photocatalyst to generate hydroxy oxide OH, which breaks the bond of organic substances in waste gas, and then discharges harmless water and CO2.

The waste gas in the waste gas pipeline 3 is degraded by the waste gas treatment device 12 after volume expansion. Multiple waste gas treatment devices 12 can improve the degradation efficiency. Compared with the overall degradation device, the degradation quality will not be low because the waste gas in the pipeline does not react in some parts of the device. At the same time, the degradation power of the waste gas treatment device 12 can be adjusted by detecting the waste gas flow, and the degradation power can be matched reasonably, Prevent excessive reaction of the device from waste of power consumption and insufficient catalytic reaction leading to incomplete degradation;

The exhaust gas quality sensor 10 set at the polymerization exhaust pipe 4 can detect the degraded organic matter to judge the degradation quality. When the degradation is not up to the standard, start the recovery exhauster 9, open the corresponding recovery pipeline valve 6 to recycle and reprocess the substandard treated gas, and increase the degradation power of the waste gas treatment unit 12 corresponding to the substandard group to improve the degradation efficiency.

The above treatment and exhaust frame 1 is separated into an input end and an output end by a support plate 11. The exhaust gas treatment device 12 is arranged at the input end and fixedly connected with the support plate 11. The exhaust end of the exhaust gas treatment device 12 extends out of the support plate 11 and enters the output end and is connected with the polymerization exhaust pipe 4.

The support plate 11 serves as the installation support for the waste gas treatment device 12, and separates the treatment and exhaust frame 1 into several independent spaces with the partition plate 13 and the inner wall of the treatment and exhaust frame 1. Each space can degrade the waste gas.

The two ends of the expansion guide groove 2 are separated by the expansion partition 21. The position of the expansion partition 21 at the output end of the expansion guide groove 2 corresponds to the position of the partition 13 of the treatment and exhaust frame 1.

The waste gas input into the waste gas pipeline 3 is expanded and guided through the expansion partition 21, and enters a number of independent spaces separated by the partition 13. The waste gas treatment device 12 in the space conducts degradation treatment, which can increase the reaction area of the waste gas and improve the catalytic reaction efficiency.

The exhaust gas flow sensor 7 and the exhaust gas quality sensor 10 are electrically connected with the input end of the exhaust gas processing controller 14, and the output end of the exhaust gas processing controller 14 is electrically connected with the exhaust gas processing device 12, the recovery pipeline valve 6 and the recovery exhauster 9.

The waste gas treatment controller 14 controls the waste gas treatment device 12 to generate the corresponding degradation power through the waste gas flow data transmitted by the waste gas flow sensor 7, and then detects the degradation quality according to the exhaust gas quality sensor 10 at the polymerization exhaust pipe 4. When the degradation quality at the polymerization exhaust pipe 4 does not meet the standard, start the recovery exhauster 9 and open the corresponding recovery pipe valve 6 to recycle and re degrade the exhaust gas, At the same time, calculate the degradation power data that should be increased according to the degradation quality data and control the waste gas treatment device 12 to increase to the specified power.

The above-mentioned exhaust gas processing controller 14 is connected with the analog quantity module 16 in communication, the exhaust gas flow sensor 7 and the exhaust gas quality sensor 10 are electrically connected with the input end of the analog quantity module 16, and the output end of the analog quantity module 16 is electrically connected with the exhaust gas processing device 12.

The transmitter of the exhaust gas flow sensor 7 and the exhaust gas quality sensor 10 converts the flow and organic matter data into the corresponding analog quantity voltage or current, which enters the analog quantity module 16, which converts the analog quantity into the corresponding digital quantity value, calculates the current flow and organic matter values, and transmits them to the exhaust gas treatment controller 14, The waste gas treatment controller 14 calculates the required degradation power value and regulation power value and sends them to the analog quantity module 16, which converts them into control analog quantity voltage or current and sends them to the waste gas treatment device 12.

The above-mentioned waste gas treatment device 12 includes a waste gas treatment frame 121, on which a microwave generator 122 is fixed. The waste gas treatment frame 121 is a frame through the inside. Both ends of the waste gas treatment frame 121 are respectively provided with an air inlet filter plate 123 and an air outlet plate 124. The middle of the waste gas treatment frame 121 is provided with a photocatalyst plate 125, and both sides of the photocatalyst plate 125 are provided with an ultraviolet lamp tube 126 electrically connected with the microwave generator 122.

VOCs waste gas enters the waste gas treatment frame 121 after the micro particles are filtered out by the air inlet filter plate 123. The microwave generator 122 controls the ultraviolet lamp 126 to generate bUVC rays with a wavelength of 253.7 nm, and generates microwave ultrahigh frequency electromagnetic fields. The microwave ultrahigh frequency electromagnetic fields pre split VOCs molecules, cut them into small molecules, and then break the bonds of small molecules of VOCs gas through bUVC rays, At the same time, bUVC radiation irradiates the nano coating of TiO2 on the photocatalyst plate 125 to produce hydroxy oxide OH, and the bond breaking energy (BDE) of hydroxy oxide OH is 13 times that of ozone (03), so the photocatalysis efficiency is higher, the bond breaking is more thorough, and VOCs gas is converted into harmless water and CO2.

The waste gas treatment device 12 of the corresponding group of the polymerization exhaust pipe 4 shares a microwave generator 122, and the output end of the analog quantity module 16 is electrically connected with the microwave generator 122.

The waste gas treatment device 12 connected to the polymerization exhaust pipe 4 of the same group forms a control unit. Whether the waste gas treatment device 12 of this group increases the degradation power is determined by the exhaust gas quality sensor 10.

The partition 13 is composed of vertical and horizontal straight plates, which separates the input end of the processing and exhaust frame 1 into a number of cuboid spaces. The exhaust gas processing devices 12 in the cuboid space of the same horizontal line form a group and are connected with the polymerization exhaust pipe 4.

The input end of the treatment and exhaust frame 1 is separated into roughly the same cuboid space. The waste gas in each space is degraded by the waste gas treatment device 12. The waste gas in the pipeline, including the gas in the center and edge of the pipeline, is directed to an independent space for treatment, avoiding the reduction of treatment efficiency caused by the difficulty of contacting the corners of the integrated treatment.

The above-mentioned waste gas treatment controller 14 is electrically connected and controlled with the recovery pipeline valve 6 and the recovery exhauster 9 through the control relay 17.

The above-mentioned waste gas treatment controller 14 is communicated with the display screen 15.

The display screen 15 uses a touch screen, which can be used to control parameter settings and display the degradation process.

The waste gas treatment method using the micro ultraviolet waste gas treatment device is as follows:
Step 1: VOCs waste gas enters the waste gas pipe 3 and reaches the intake end of the treatment and exhaust frame 1 through the expansion guide slot 2. The waste gas flow sensor 7 senses the current waste gas flow;
Step 2: the waste gas treatment controller 14 calculates the initial degradation power according to the flow transmitted by the waste gas flow sensor 7, and generates control analog voltage/current and sends it to each microwave generator 122;
Step 3: The microwave generator 122 receives the voltage/current of the control analog quantity, generates the microwave ultrahigh frequency electromagnetic field in the waste gas treatment frame 121, and generates bUVC rays from the ultraviolet lamp tube 126 with the wavelength of 253.7 nm. The ultraviolet lamp tube 126 uses the ultraviolet sterilization lamp driven by amalgam;
Step 4: The microwave UHF electromagnetic field pre splits the VOCs molecules in the space separated by the baffle 13 and the support plate 11 into small molecules;
Step 5: bUVC ray is used to break bonds and photolysis VOCs gas cut into small molecules;
Step 6. At the same time of step 4 and step 5, bUVC radiation irradiates the nano coating of TiO2 on the photocatalyst plate 125 to catalyze the generation of hydroxy oxide radical OH, which further breaks the bond of waste gas to convert VOCs into harmless water and CO2;
Step 7: The exhaust gas quality sensor 10 at the polymerization exhaust pipe 4 detects the exhaust gas quality of each group and sends the detection result to the exhaust gas processing controller 14, which compares the detection result with the set value to determine whether the exhaust gas quality is up to standard. If all of them are up to standard, the exhaust gas treatment is completed. If the exhaust gas quality of a group is not up to standard, go to step 8;
Step VIII. The waste gas treatment controller 14 controls the opening of the recovery pipeline valve 6 of the group whose exhaust gas quality is not up to the standard, starts the recovery exhauster 9, and recovers the gas discharged from the polymerization exhaust pipe 4 of the group whose exhaust gas quality is not up to the standard to the waste gas pipeline 3. The waste gas treatment controller 14 recalculates the secondary degradation power data of each group based on the data of the exhaust gas quality that is not up to the standard, and generates the control analog voltage/current to send to each microwave generator 122, Repeat steps 3 to 7 until the exhaust quality of all groups reaches the standard, stop the recovery exhauster 9 and close the recovery pipeline valve 6.

1. A micro ultraviolet waste gas treatment device, comprising a waste gas pipe (3) and an expansion guide groove (2) connected with it, the outlet end of the expansion guide groove (2) and the treatment and exhaust frame (1), the inlet end of the treatment and exhaust frame (1) is separated into a plurality of spaces by a partition plate (13), and each space is provided with a waste gas treatment device (12), The outlet end of the waste gas treatment device (12) is connected and combined into multiple groups through the polymerization exhaust pipe (4), each polymerization exhaust pipe (4) is provided with a recovery pipe (5), the recovery pipe (5) is polymerized into a recovery main pipe (8) at the inlet end of the waste gas pipe (3) and connected with the waste gas pipe (3), the recovery main pipe (8) is provided with a recovery exhauster (9), and the waste gas pipe (3) is provided with a waste gas flow sensor (7), each recovery pipe (5) is equipped with a recovery pipe valve (6), and an exhaust gas quality sensor (10) is installed at the exhaust outlet of the polymerization exhaust pipe (4), the waste gas treatment device (12) degrades the waste gas by generating ultraviolet light and photocatalyst, and the degradation power of the waste gas treatment device (12) is controlled.

2. The micro ultraviolet waste gas treatment device according to claim 1, wherein the treatment and exhaust frame (1) is separated into an input end and an output end by a support plate (11), the waste gas treatment device (12) is arranged at the input end and is fixedly connected with the support plate (11), and the exhaust end of the waste gas treatment device (12) extends out of the support plate (11) and enters the output end and is connected with the polymerization exhaust pipe (4).

3. The micro ultraviolet waste gas treatment device according to claim 2, wherein the two ends of the expansion guide groove (2) are separated by an expansion partition (21), and the position of the expansion partition (21) at the output end of the expansion guide groove (2) corresponds to the position of the partition (13) of the treatment and exhaust frame (1).

4. The micro ultraviolet waste gas treatment device according to claim 3, wherein the waste gas flow sensor (7) and the exhaust gas quality sensor (10) are electrically connected with the input end of the waste gas treatment controller (14), and the output end of the waste gas treatment controller (14) is electrically connected with the waste gas treatment device (12), the recovery pipeline valve (6) and the recovery exhauster (9).

5. The micro ultraviolet waste gas treatment device according to claim 4, wherein the waste gas treatment controller (14) is communicated with an analog module (16), the waste gas flow sensor (7) and the exhaust gas quality sensor (10) are electrically connected with the input end of the analog module (16), and the output end of the analog module (16) is electrically connected with the waste gas treatment device (12).

6. The micro ultraviolet waste gas treatment device according to claim 5, wherein the waste gas treatment device (12) comprises a waste gas treatment frame (121), a microwave generator (122) is fixed on the waste gas treatment frame (121), the waste gas treatment frame (121) is a frame through the interior, and both ends of the waste gas treatment frame (121) are respectively provided with an air inlet filter plate (123) and an air outlet plate (124), The middle part of the waste gas treatment frame (121) is provided with a photocatalyst plate (125), and both sides of the photocatalyst plate (125) are provided with an ultraviolet lamp tube (126) electrically connected with the microwave generator (122).

7. The micro ultraviolet waste gas treatment device according to claim 6, wherein the corresponding group of waste gas treatment devices (12) of the polymerization exhaust pipe (4) share a microwave generator (122), and the output end of the analog quantity module (16) is electrically connected with the microwave generator (122).

8. The micro ultraviolet waste gas treatment device according to claim 7, wherein the diaphragm (13) is composed of vertical and horizontal straight plates, the input ends of the treatment and exhaust frames (1) are separated into a plurality of cuboid spaces, and the waste gas treatment devices (12) within the cuboid space of the same horizontal line form a group which is connected with the polymerization exhaust pipe (4).

9. The micro ultraviolet waste gas treatment device according to claim 8, wherein the waste gas treatment controller (14) is electrically connected and controlled with the recovery pipeline valve (6) and the recovery exhauster (9) through the control relay (17), and the waste gas treatment controller (14) is communicated with the display screen (15).

10. The waste gas treatment method using the micro ultraviolet waste gas treatment device according to claim 9, wherein the treatment steps are:
Step 1: VOCs waste gas enters the waste gas pipe (3) and reaches the intake end of the treatment and exhaust frame (1) through the expansion guide groove (2), the waste gas flow sensor (7) senses the current waste gas flow;
Step 2: The waste gas treatment controller (14) calculates the initial degradation power according to the flow transmitted by the waste gas flow sensor (7), and generates control analog voltage/current to send to each microwave generator (122);
Step 3: The microwave generator (122) receives the voltage/current of the control analog quantity, generates the microwave ultrahigh frequency electromagnetic field in the waste gas treatment frame (121), and generates bUVC rays from the ultraviolet lamp tube (126) with a wavelength of 253.7 nm. The ultraviolet lamp tube (126) uses an ultraviolet disinfection lamp driven by an amalgam;
Step 4: The microwave UHF electromagnetic field pre splits the VOCs molecules in the space separated by the baffle (13) and the support plate (11) into small molecules;
Step 5: bUVC ray is used to break bonds and photolysis VOCs gas cut into small molecules;
Step 6: At the same time of step 4 and step 5, bUVC radiation irradiates the nano coating of TiO2 on the photocatalyst plate (125) to catalyze the generation of hydroxy oxide radical OH, which further breaks the bond of waste gas to convert VOCs into harmless water and CO2;
Step 7: The exhaust gas quality sensor (10) at the polymerization exhaust pipe (4) detects the exhaust gas quality of each group, and sends the detection results to the exhaust gas processing controller (14), which compares the detection results with the set values to determine whether the exhaust gas quality is up to standard, if all of them are up to standard, the exhaust gas treatment is completed. If the exhaust gas quality of a group is not up to standard, go to step 8;
Step VIII, the waste gas treatment controller (14) controls the opening of the recovery pipe valve (6) of the group with substandard exhaust gas quality, starts the recovery exhauster (9), recovers the exhaust gas in the polymerization exhaust pipe (4) of the group with substandard exhaust gas quality to the waste gas pipe (3), and the waste gas treatment controller (14) recalculates the secondary degradation power data of each group based on the substandard exhaust gas quality, the control analog quantity voltage/current is generated and sent to each microwave generator (122), repeat steps 3 to 7 until the exhaust quality of all groups reaches the standard, stop the recovery exhauster (9) and close the recovery pipeline valve (6).
